(19) United States
(12) Patent Application Publication
(10) Pub. No.: US 2026/0195616 A1
(43) Pub. Date: Jul. 9, 2026

(54) FINE-TUNING A LARGE MODEL AND USING THE LARGE MODEL TO EXECUTE A TASK

(71) Applicant: INTERNATIONAL BUSINESS MACHINES CORPORATION, ARMONK, NY (US)

(72) Inventors: Kun Yan Yin, Ningbo (CN); Yuan Yuan Ding, Shanghai (CN); Shi Yun Liang, Shanghai (CN); Yu Pan, Shanghai (CN)

(21) Appl. No.: 19/010,737

(22) Filed: Jan. 6, 2025

(51) Int. Cl. G06N 5/04; G06V 20/50; G06V 30/10

(52) U.S. Cl. CPC G06N 5/04; G06V 20/50; G06V 30/10

(57) ABSTRACT

Provided are techniques for fine-tuning a large model and using the large model to execute a task. Content from an image is extracted, where the content includes a summary of the image, objects in the image, locations of objects in the image, and any text found in the image. Question and answer pairs are generated from the content. A subset of the question and answer pairs for which an answer to a question is correct is identified. The subset of the question and answer pairs are used to fine-tune a large model. A question is received from a user. The question is input into the fine-tuned large model. An answer to the question is received from the fine-tuned large model. The answer is returned to the user.

### BACKGROUND

Embodiments of the invention relate to fine-tuning a large model (i.e., a machine learning model) and using the large model to execute a task. In particular, embodiments of the invention relate to an agent-based technique for accelerating a multimodal fine-tune process for improved execution of the task.

A machine learning model is initially trained with a base or training data set to perform a task. Over time, the machine learning model is fine-tuned with additional data to perform the task.

### SUMMARY

In accordance with certain embodiments, a computer-implemented method comprising operations is provided for fine-tuning a large model and using the large model to execute a task. In such embodiments, content from an image is extracted, where the content includes a summary of the image, objects in the image, locations of objects in the image, and any text found in the image. Question and answer pairs are generated from the content. A subset of the question and answer pairs for which an answer to a question is correct is identified. The subset of the question and answer pairs are used to fine-tune a large model. A question is received from a user. The question is input into the fine-tuned large model. An answer to the question is received from the fine-tuned large model. The answer is returned to the user.

In accordance with other embodiments, a computer program product comprising a computer readable storage medium having program code embodied therewith is provided, where the program code is executable by at least one computer processor to perform operations for fine-tuning a large model and using the large model to execute a task. In such embodiments, content from an image is extracted, where the content includes a summary of the image, objects in the image, locations of objects in the image, and any text found in the image. Question and answer pairs are generated from the content. A subset of the question and answer pairs for which an answer to a question is correct is identified. The subset of the question and answer pairs are used to fine-tune a large model. A question is received from a user. The question is input into the fine-tuned large model. An answer to the question is received from the fine-tuned large model. The answer is returned to the user.

In accordance with yet other embodiments, a computer system comprises one or more computer processors, one or more computer-readable memories and one or more computer-readable, tangible storage devices; and program instructions, stored on at least one of the one or more computer-readable, tangible storage devices for execution by at least one of the one or more computer processors via at least one of the one or more memories, to perform operations for fine-tuning a large model and using the large model to execute a task. In such embodiments, content from an image is extracted, where the content includes a summary of the image, objects in the image, locations of objects in the image, and any text found in the image. Question and answer pairs are generated from the content. A subset of the question and answer pairs for which an answer to a question is correct is identified. The subset of the question and answer pairs are used to fine-tune a large model. A question is received from a user. The question is input into the fine-tuned large model. An answer to the question is received from the fine-tuned large model. The answer is returned to the user.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a computing environment of a fine-tuning system in accordance with certain embodiments.

FIG. 3 illustrates further details of the fine-tunings system and machine learning models in accordance with certain embodiments.

FIGS. 4A and 4B illustrate automobile wheel hubs in accordance with certain embodiments.

FIG. 5 illustrates example training data in accordance with certain embodiments.

FIG. 6 illustrates an image with a question and answer in accordance with certain embodiments.

FIG. 7 illustrates operations of the fine-tuning system in accordance with certain embodiments.

FIG. 8 illustrates example training data of a Multimodal Large Language Model (MLLM) in accordance with certain embodiments.

FIG. 9 illustrates operations for preparing data in accordance with certain embodiments.

FIG. 10 illustrates auto-content extraction in accordance with certain embodiments.

FIG. 11 illustrates a conversations template for auto-conversation generation in accordance with certain embodiments.

FIG. 12A illustrates a prompt template for auto-review in accordance with certain embodiments.

FIG. 12B illustrates an auto-reviewer inputs and outputs in accordance with certain embodiments.

FIG. 13A illustrates operations for generating a conversion script for use in fine-tuning in accordance with certain embodiments.

FIG. 13B illustrates fine-tuning API inputs and outputs in accordance with certain embodiments.

FIG. 14 illustrates, in a flowchart, operations for fine-tuning a large model and using the large model to execute a task in accordance with certain embodiments.

FIG. 15 illustrates, in a block diagram, details of a machine learning model 1500 in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

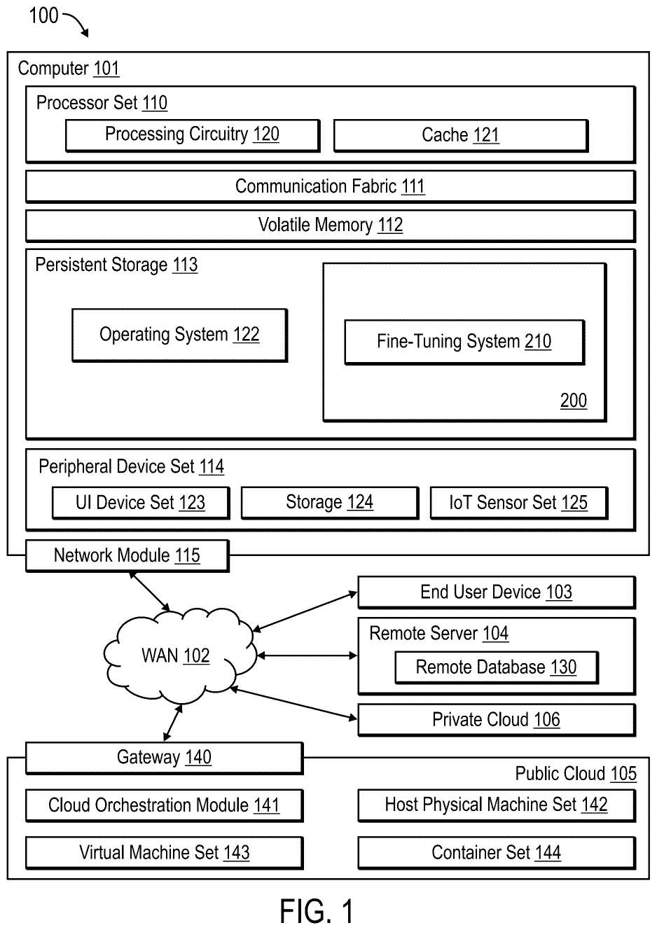

Computing environment 100 of FIG. 1 contains an example of an environment for the execution of at least some of the computer code involved in performing the inventive methods, such as fine-tuning system 210 of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

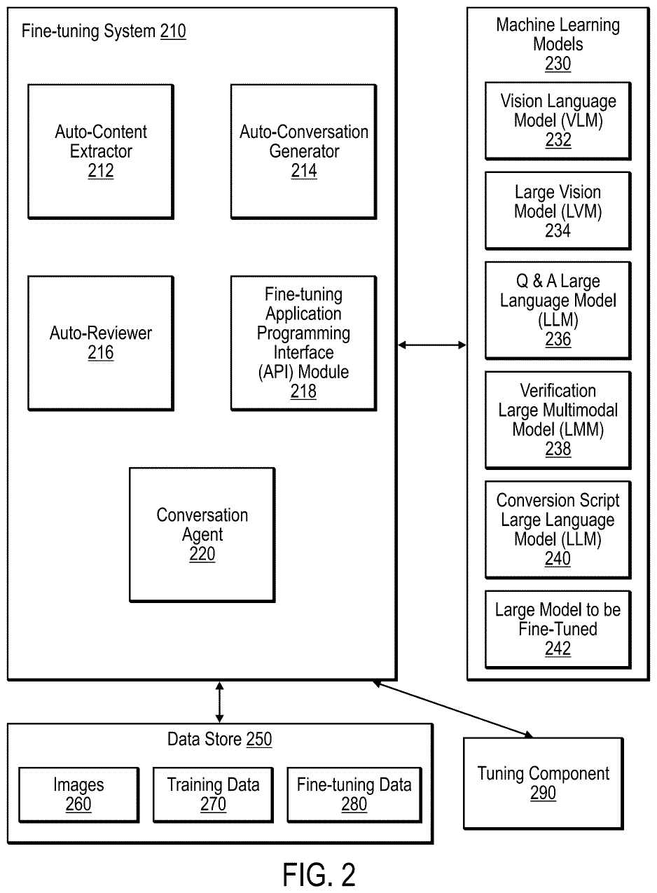

FIG. 2 illustrates a computing environment of a fine-tuning system 210 in accordance with certain embodiments. The fine-tuning system 210 includes an auto-content extractor 212, an auto-conversation generator 214, an auto-reviewer 216, and a fine-tuning Application Programming Interface (API) module 218, and a conversation agent 220. The fine-tuning system 210 is connected to machine learning models 230 and to a data store 250. The data store 250 stores images 260, training data 270, and fine-tuning data 280.

The machine learning models 230 include: at least one Vision Language Model (VLM) 232 for extracting the content or the summary of an image, at least one Large Vision Model (LVM) 234 for object detection or Optical Character Recognition (OCR), at least one Question and Answer (Q&A) Large Language Model (LLM) 236 for generating Q&A pairs, at least one verification Large Multimodal Model (LMM) 238 for reviewing the Q&A pairs, at least one conversion script Large Language Model (LLM) 240 for generating a conversion script, and at least one large model to be fine-tuned 242 (e.g., a Multimodal Large Language Model (MLLM).

In certain embodiments, the fine-tuning system 210 fine-tunes a multimodal LLM such as a conversation multimodal LLM, which may be used in various conversation scenarios.

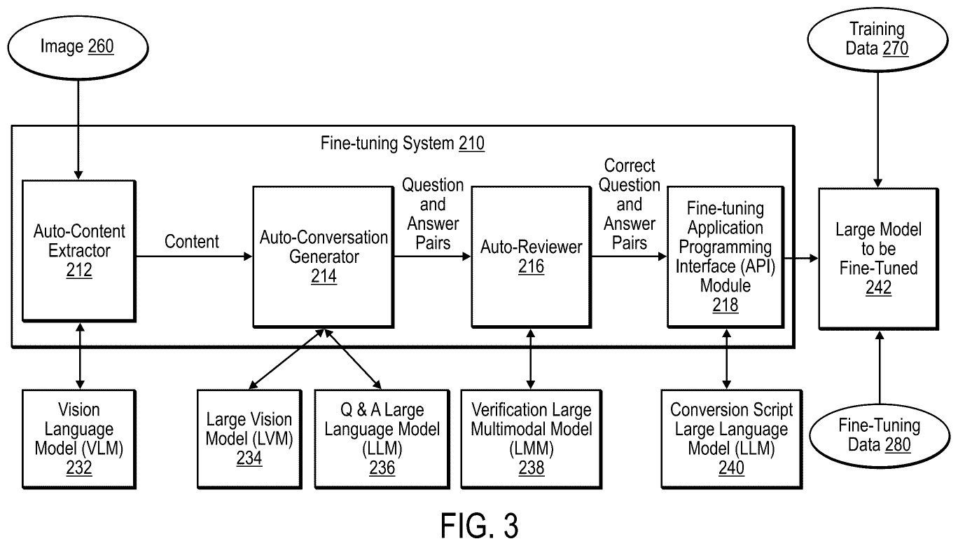

FIG. 3 illustrates further details of the fine-tunings system and machine learning models in accordance with certain embodiments. The auto-content extractor 212 receives an image 260 and inputs the image 260 into a Vision Language Model (VLM) 232, which outputs a summary of the image 260. The auto-content extractor 212 also detects objects and locations of the objects in the image 260. In addition, the auto-content extractor 212 identifies any OCR information (i.e., text) in the image 260. In certain embodiments, “content” includes: the summary, the objects and their locations, and any text. The auto-content extractor 212 sends the content to the auto-conversation generator 214. In certain embodiments, the auto-content extractor 212 may also send the image to the auto-conversation generator 214.

The auto-conversation generator 214 receives the content output by the auto-content extractor 212. The auto-conversation generator 214 inputs the content (e.g., the summary, the objects, and the OCR information) into a Q&A Large Language Model 236, which outputs conversations made up of question and answer pairs (e.g., question1- answer1, question2- answer2, etc.). The auto-conversation generator 214 sends the question and answer pairs to the auto-reviewer 216.

The auto-reviewer 216 receives the question and answer pairs and background information and inputs these into a verification Large Multimodal Model (LMM) 238, which outputs true or false for each question and answer pair, where true indicates that the answer is correct for the question and false indicates that the answer is not correct for the question. The auto-reviewer 216 sends the correct question and answer pairs to the fine-tuning API module 218, while not sending any incorrect question and answer pairs.

The fine-tuning API module 218 receives the correct question and answer pairs from the auto-reviewer 216. The fine-tuning API module 218 inputs information related to an input data format and an output data format into a conversion script Large Language Model (LLM) 240, which outputs a conversion script that indicates how to covert the format of the questions and answers to a format that the large model to be fine-tuned 242 is expecting. The fine-tuning API module 218 uses the conversion script to format the correct questions and answers. The large model to be fine-tuned 242 is initially trained with training data 270. Then, the fine-tuning API module 218 uses the formatted, correct questions and answers to fine-tune the large model to be fine-tuned 242. In certain embodiments, the fine-tuning API module 218 invokes a tuning component 290 that fine-tunes the large model to be fine-tuned 242.

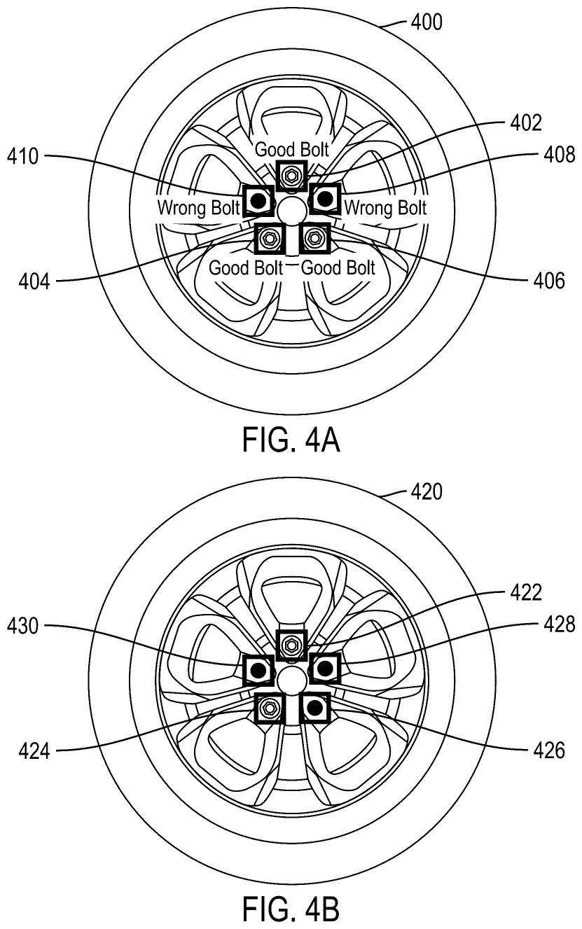

Merely to enhance understanding of embodiments, examples are provided herein. FIGS. 4A and 4B illustrate automobile wheel hubs in accordance with certain embodiments. In this example of an industrial scenario, the automobile wheel hubs are inspected after production. For example, in FIG. 4A, the wheel 400 includes three correct (i.e., good) bolts 402, 404, 406 and two incorrect (i.e., wrong) bolts 408, 410. A machine learning model 230 may be an object detection model that is trained on the training dataset. It is possible for the shape of the wheel hub on the production line to change, and the machine learning model 230 trained with pictures collected by a laboratory in advance of production may be difficult to adapt to other wheel hub lines and the accuracy of the machine learning model 230 trained on the training data may be less than desired.

The fine-tuning system 210 feeds the images 260 directly into a Large Multimodal Model (LMM) to get detection results. For some general images in daily life or on the network, the detection accuracy of the a Large Multimodal Model (LMM) is relatively stable. However, for some industrial images, especially in some very specific scenarios, the detection result of the a Large Multimodal Model (LMM) may be less than desired. For example, in FIG. 4B, the a Large Multimodal Model (LMM) detects two correct (i.e., good) bolts 422, 424 and three incorrect (i.e., wrong) bolts 426, 428, 430. That is, the a Large Multimodal Model (LMM) detects the correct bolt 406 as an incorrect bolt 426. Thus, the fine-tuning system 210, in order to adapt to the needs of a particular task or domain, fine-tunes such large models so that they correctly identify the bolts.

Conventional large machine learning model fine-tuning frameworks involve time-consuming processes and require a high level of specialized skills from users, which limits their widespread adoption.

Compared to a unimodal Large Language Model (LLM), the a Large Multimodal Model (LMM) handles multiple types of data (e.g., text, images, and audio), but faces challenges during fine-tuning. The fine-tuning process for the Large Multimodal Model (LMM) is not only more complex but also requires a substantial amount of data. The creation of training data poses a challenge to engineers'technical skills. Engineers spend time annotating and preparing data. However, the manually created data often contains biases, making it difficult for the trained model to meet project requirements.

On the other hand, the fine-tuning system 210 provides a training framework for large models (e.g., a Large Multimodal Model (LMM)) that is easy to get started with. This framework allows users to specify project requirements and provide a small amount of sample data, and then the fine-tuning system 210 rapidly generates a large volume of high-quality synthetic data (i.e., Q & A pairs) for model fine-tuning. This approach reduces the fine-tuning time from one week to half a day and saves 80% labor. The fine-tuning system 210 not only enhances the efficiency of fine-tuning the a Large Multimodal Model (LMM) but also lowers labor costs, providing strong support for the widespread application of a Large Multimodal Model (LMM).

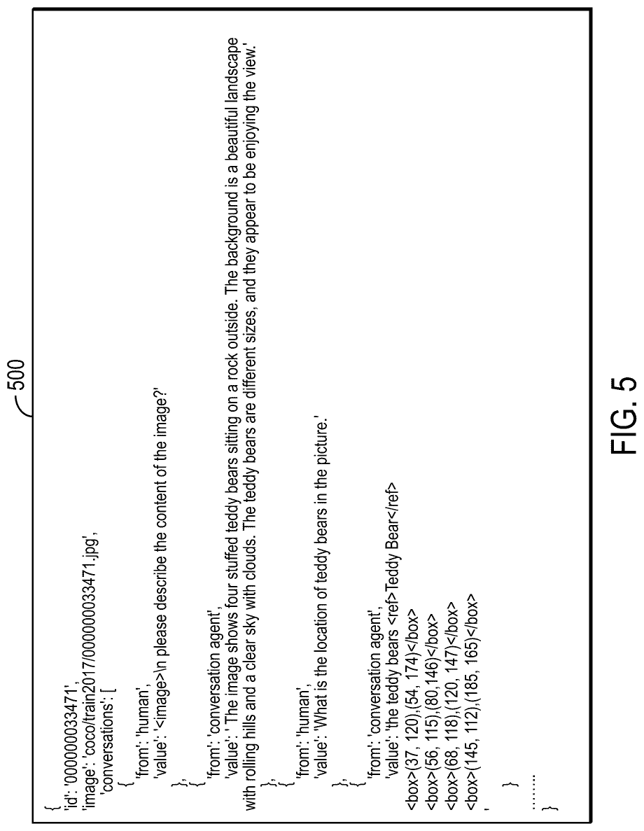

FIG. 5 illustrates example training data 500 in accordance with certain embodiments. The training data 500 includes an identifier of an image and the location of the image. Then, the training data 500 includes a conversation between a human and the conversation agent. A conversation may be described as one or more requests (e.g., questions) from the human and a corresponding answer from the conversation agent.

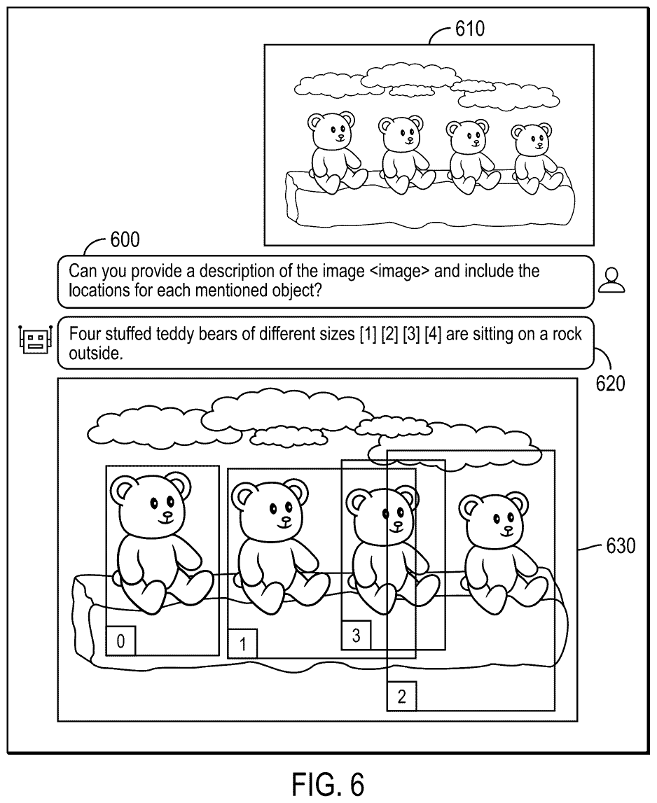

FIG. 6 illustrates an image with a question and answer in accordance with certain embodiments. In this example, a request 600 for a description of the image 610 is input, and a machine learning model 230 provides an answer 620 with an updated image 630.

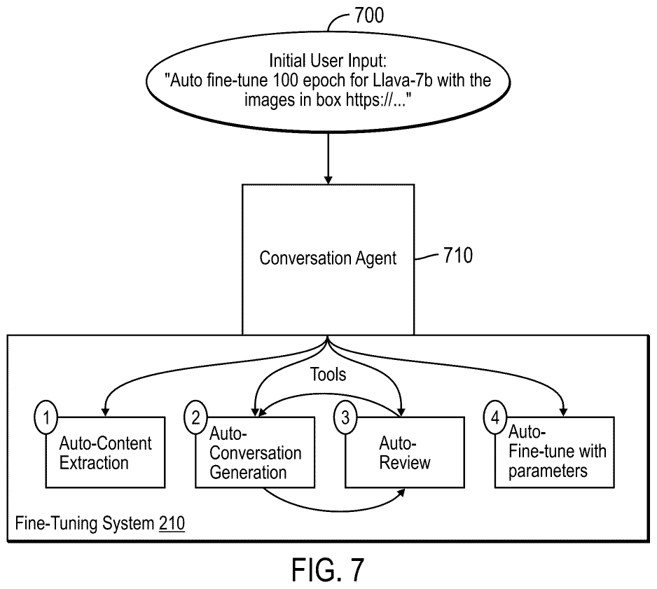

FIG. 7 illustrates operations of the fine-tuning system 210 in accordance with certain embodiments. A conversation agent 710 receives initial user input to fine-tune a large model. The conversation agent 710 interacts with the fine-tuning system to fine-tune the large model. In certain embodiments, the fine-tuning system 210 provides the conversation agent 710 to accelerate the fine-tune process with different tools, including automatically extracting content, generating multimodal conversation data, reviewing the multimodal conversation data, and supporting different model format conversions and fine-tune models.

In certain embodiments, for the auto-content extraction, the fine-tuning system 210 provides an interface that sends batch images with few shot examples to the auto-content extractor 212. Few shot examples refers to training a machine learning model on a small number of labeled examples. The auto-content extractor 212 understands the batch images and extracts a summary of each image and objects with locations in each image automatically.

In certain embodiments, for the auto-conversation generation, the fine-tuning system 210 automatically generates conversations from different views based on the content extraction. These conversations provide question and answer pairs that are the raw data for fine-tuning the large model.

In certain embodiments, for the auto-review, the fine-tuning system 210 automatically reviews the question and answer pairs from the conversation generation based on format and at least one verification Large Multimodal Model (LMM) 238 to identify correct question and answer pairs.

In certain embodiments, for the auto-finetune, the fine-tuning system 210 provides a fine-tuning API that may be used to trigger fine-tuning of the large model with different parameters and the correct question and answer pairs. Example parameters include: model, data path, fine-tune technique, epoch, and other metadata.

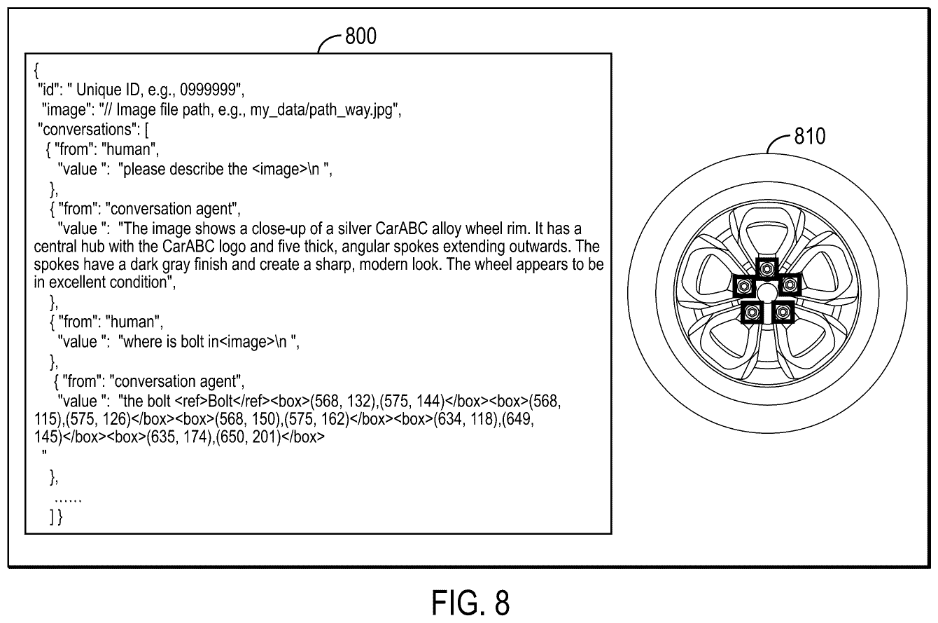

FIG. 8 illustrates example training data 800 of a Multimodal Large Language Model (MLLM) in accordance with certain embodiments. The training data 800 includes an identifier of an image and the location of the image. For this example, the image 810 includes the wheel and bolts. Then, the training data 800 includes conversations between a human and the conversation agent.

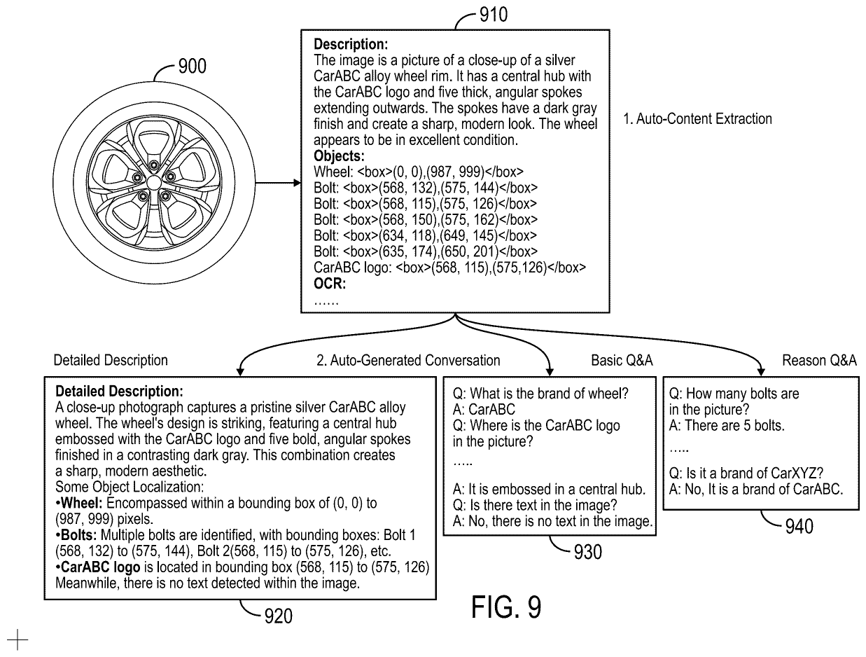

FIG. 9 illustrates operations for preparing data in accordance with certain embodiments. In FIG. 9, the auto-content extractor 212 of the fine-tuning system 210 extracts content 910 from the image 900. The auto-conversation generator 214 of the fine-tuning system 210 uses the content 910 to generate a detailed description 920 and the conversations 930, 940.

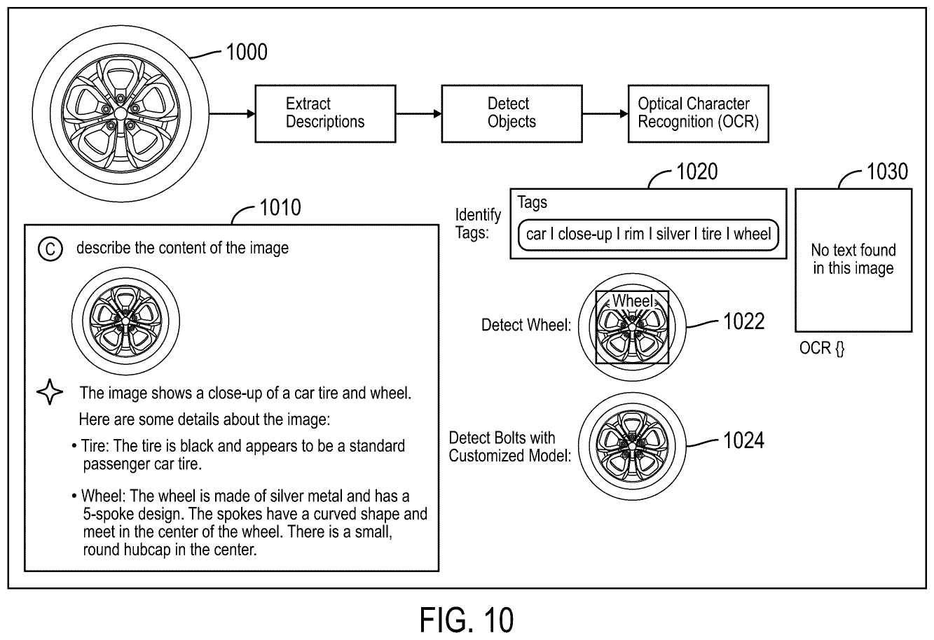

FIG. 10 illustrates auto-content extraction in accordance with certain embodiments. The auto-content extractor 212 of the fine-tuning system 210 automatically extracts a description of the image, detects objects in the image, and obtains text in the image with machine learning models.

Initially, the auto-content extractor 212 receives an image 1000. The auto-content extractor 212 extracts a description 1010 of the image 1000. In certain embodiments, the auto-content extractor 212 uses a Vision Language Model (VLM) to obtain the description 1010 with a prompt such as “describe the content of the image”.

The auto-content extractor 212 detects candidate tags 1020 and objects 1022, 1024 in the image 1000. In particular, the auto-content extractor 212 identifies the objects 1022, 1024 (e.g., wheel and bolts) and candidate tags 1020 of the objects 1022, 1024. Then, the auto-content extractor 212 detects the locations of the objects in the image 1000). In certain embodiments, the auto-content extractor 212 extracts customized objects (e.g., “bolts” 1024) by training a customized object detection machine learning model (e.g., a VLM for the customized objects) for use in detecting the bolts.

The auto-content extractor 212 performs OCR on any text in the image 1000. In certain embodiments, the auto-content extractor 212 uses open source OCR tools to extract the text in the image. In image 1000, the auto-content extractor 212 has found no text.

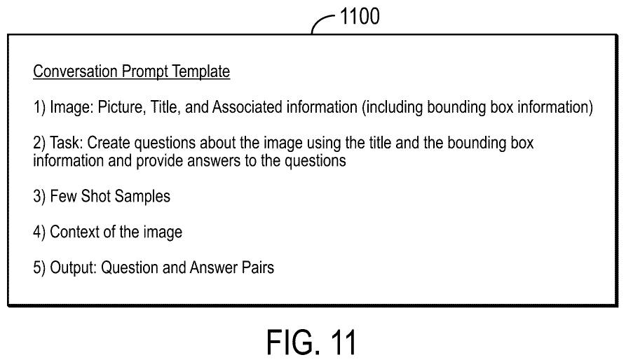

FIG. 11 illustrates a conversations template for auto-conversation generation in accordance with certain embodiments. In certain embodiments, the auto-conversation generation 214 uses a Large Language Model (LLM) to generate questions and answers. The auto-conversation generator 214 of the fine-tuning system 210 generates the conversation based on the conversation prompt template 1100.

The conversation prompt template 1100 includes the image. The image has content of the picture, a title, and associated information (including bounding box information). In certain embodiments, the auto-conversation generator 214 uses a machine learning model (e.g., an AI visual assistant) that analyzes the image and outputs sentences describing the picture, provides the location of specific objects within the picture with coordinates. These coordinates are expressed in the form of a bounding box, expressed as four floating point numbers (x1, y1, x2, y2) ranging from 0 to 1. With the values, (x1, y1) represent the upper left corner of the bounding box, while (x2, y2) represent the lower right corner of the bounding box.

The conversation prompt template 1100 includes a task. In certain embodiments, the auto-conversation generator 214 creates complex questions that go beyond describing scenarios. To answer such complex questions, the auto-conversation generator 214 first understands the visual content and then, based on background knowledge or reasoning, explains why something is happening or provides guidance and assistance in response to a user's request (i.e., question). The auto-conversation generator 214 may not include visual content details in the question. The auto-conversation generator 214, when describing the scene, may not mention the bounding box coordinates directly in the question, but may use the bounding box coordinates to explain the scene in natural language by including details such as the number of objects, the location of the objects, and the relative positions of the objects to each other. When using information from titles and bounding box coordinates, the auto-conversation generator 214 explains the scene directly and may not mention whether the source of the information is the title or the bounding box coordinates. Also, the auto-conversation generator 214 generates an answer as if looking directly at the picture. Moreover, the auto-conversation generator 214 outputs the question and the answer separately (e.g., separated by a line (—)).

The conversation prompt template 1100 includes few shot samples. “Few shot samples” refers to using a small number of examples to guide a the model's response to the task.

The auto-conversation generator 214 generates the samples. In this example, the samples represent generation of Q & A pairs based on content of a certain description, summary, bounding box, OCR text, etc. from an image. When given the content of another image (description, summary, bounding box, OCR text, etc.), the auto-conversation generator 214 is able to generate the Q & A pairs based on the content of that other image. For example, the following are examples of context: 1) a person is wearing multiple ties; 2) a person is wearing a white shirt and has many ties; 3) a person is wearing a tie and poses for a photo; and 4) a person is wearing multiple ties around the neck. The following are examples of bounding boxes: 1) tie: [0.349, 0.363, 0.563,0.732]; 2) tie: [0.259, 0.255, 0.668, 0.805]; 3) person: [0.019, 0.065, 0.962, 0.988]; 4) person: [0.0, 0.24, 0.214, 1.0]; and tie: [0.316, 0.778, 0.443, 0.867]. The following is an example question and response: 1) question “What's unusual about this photo?” and 2) answer “In the photo, the person is wearing multiple ties around the neck. This is considered unusual as normally a person wears one tie. The person's smirking expression also adds to the unusual and humorous nature of the photo.”

The conversation prompt template 1100 includes context for the image. The auto-conversation generator 214 generates context that the image shows a close-up of a silver CarABC alloy wheel rim, which has a central hub with the CarABC logo and five thick, angular spokes extending outwards. The spokes have a dark gray finish and create a sharp, modern look. The wheel appears to be in excellent condition.

The auto-conversation generator 214 also identifies objects and bounding boxes for the objects:
Wheel: <box>(0, 0), (987, 999) </box>
Bolt: <box>(568, 132), (575, 144)</box>
Bolt: <box>(568, 115), (575, 126)</box>
Bolt: <box>(568, 150), (575, 162)</box>
Bolt: <box>(634, 118), (649, 145)</box>
Bolt: <box>(635, 174), (650, 201)</box>
CarABC logo:<box>(568, 115), (575, 126)</box>

The conversation prompt template 1100 includes output of question and answer pairs. For example, the auto-conversation generator 214 generates the following questions and answers:
Question: What is a striking feature of the image and any implications it may have?
Answer: The image showcases a close-up of a silver alloy wheel rim. The design is dominated by five thick, angular spokes that radiate from a central hub displaying the CarABC logo. While the overall aesthetic is modern and appealing, the most striking feature is a set of small objects near the wheel's center. These objects resemble bolts and are arranged in a tightly packed pattern. The implication is that the set of small objects near the wheel's center should be properly attached to the wheel for safety.
Question: Describe an overall condition of the wheel and any specific details that support the assessment.
Answer: The wheel in the image appears to be in good condition. The silver finish is lustrous and free from visible scratches or blemishes. The angular spokes are evenly spaced and exhibit a uniform dark gray coating. The CarABC logo at the wheel's center is clear and unmarred. However, it is not clear whether the set of small objects near the wheel's center are properly placed.
Question: Focusing on the set of objects near the wheel's center, what can you infer about their purpose and potential impact.
Answer: The set of small objects near the wheel's center resemble bolts. Their uniform size and shape suggest that they may have been intentionally placed.

Once the auto-conversation generator 214 generates questions and answers (i.e., results) to be used to fine-tune the LLM, the auto-reviewer 216 of the fine-tuning system 210 reviews the questions and answers for accuracy.

In certain embodiments, the LLM may output a large number of questions and answers according to the user's settings. However, the quality of the output questions and answers may be low in some scenarios, and these questions and answers should not be used for fine-tuning the LLM. Therefore, the auto-reviewer 216 reviews the questions and answers generated by the auto-conversation generator 214. In particular, the auto-reviewer 216 focuses on two aspects: format and content logic. That is, the auto-reviewer 216 determines whether the generated answer is what the user was looking for by inputting the question (i.e., whether the generated question-answer pair matches the scenario) and whether the content is reasonable. To solve this, the auto-reviewer 216 uses a general Large Multimodal Model (LMM) to review the results generated by the auto-conversation generator 214 using the LLM.

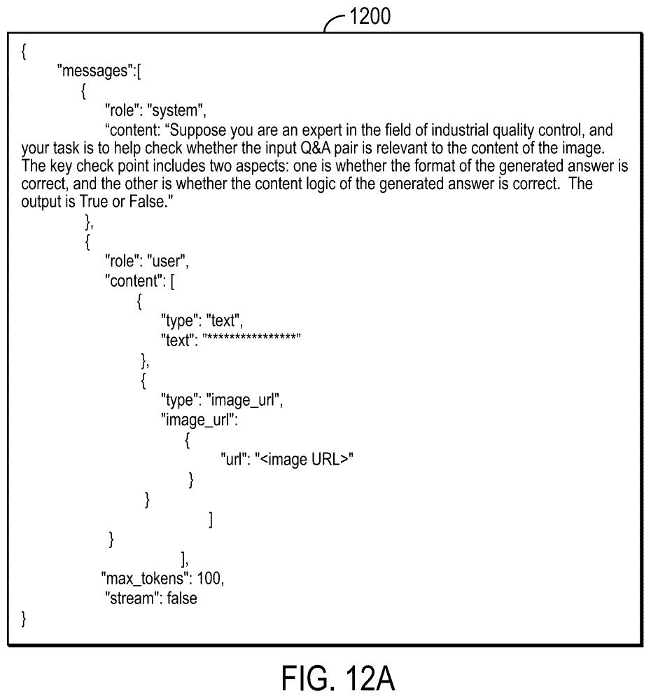

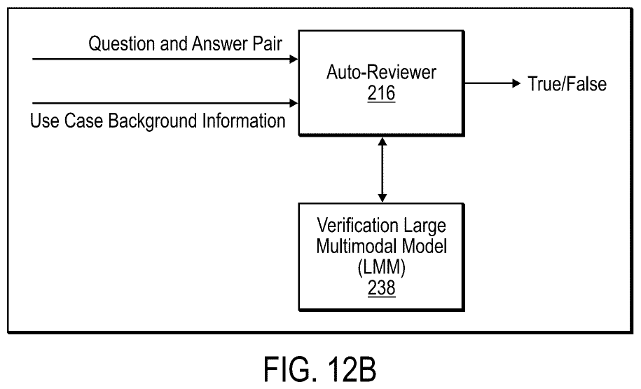

FIG. 12A illustrates use case background information 1200 for auto-review in accordance with certain embodiments. The use case background information 1200 includes messages.

FIG. 12B illustrates the auto-reviewer 216 inputs and outputs in accordance with certain embodiments. In this step, the inputs are 1) a question and answer pair generated by the auto-conversation generator 214 and 2) the use case background information 1200. Then, the auto-reviewer 216 sends these inputs to the a Large Multimodal Model (LMM) to check whether the question and answer pair generated by the Q & A Large Language Model (LLM) are correct. The auto-reviewer 216 outputs either true or false for each question and answer pair.

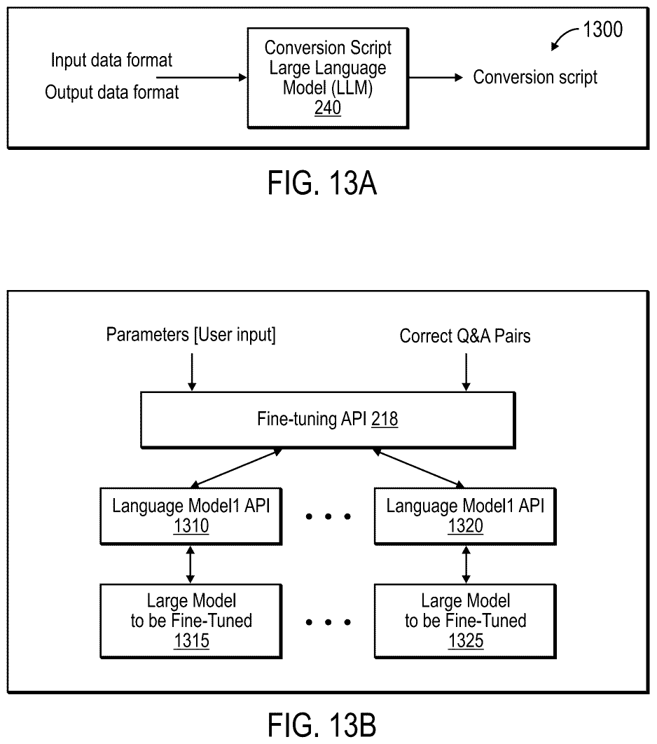

The fine-tuning API module 218 may be used to fine-tune a machine learning model, such as am LLM. Initially, the fine-tuning system 210 generates a conversion script. FIG. 13A illustrates operations for generating the conversion script 1300 for use in fine-tuning in accordance with certain embodiments. There is a README file associated with each dataset or project. Utilizing advanced Natural Language Processing (NLP) techniques, the fine-tuning system 210 analyzes the README text to extract specific information related to data formats. In certain embodiments, the fine-tuning system 210 uses pre-trained NLP models to identify and extract key sections and phrases associated with data format specifications, such as “input data format,” “data requirements,” “file format,” and similar terminology.

Based on the extracted data format information, combined with the source data format, the fine-tuning system 210 uses an LLM to automatically generate a data conversion script. The fine-tuning system 210 uses the data conversion script to perform data format conversions, transforming the source data format into the target data format expected by the LLM.

The fine-tuning system 210 runs the data conversion script to convert the data from the source data format to the target data format, ensuring that the data is ready for subsequent model processing or analysis.

FIG. 13B illustrates fine-tuning API inputs and outputs in accordance with certain embodiments. The fine-tuning API module 218 provides a unified API that allows users to fine-tune different models across various frameworks. In certain embodiments, users may specify parameters, such as model (e.g., Language Model 1, Language Model 2, etc.), a data path, a fine-tuning technique, epochs, and other relevant metadata (e.g., learning rate, batch size, etc.).

In addition, the fine-tuning API module 218 receives the correct Q&A pairs (i.e., synthetic data). Upon being triggered (e.g., initiated), the fine-tuning API module 218 intelligently routes the fine-tuning request to the appropriate model framework (e.g., Language Model 1 1310, Language Model 2 1320, etc.) and automatically configures the fine-tuning process based on the provided parameters. In certain embodiments, the fine-tuning is executed within the specified model framework, with real-time monitoring of fine-tuning progress. Upon completion, the fine-tuned model 1315, 1325 is stored for deployment or directly deployed.

In certain embodiments, the fine-tuning system 210 provides automated fine-tuning by implementing an automated conversation agent with a multimodal fine-tuning process based on natural language input. In certain embodiments, the fine-tuning system 210 provides automated synthetic data generation with an automated mechanism for generating large volumes of high-quality synthetic data (i.e., the Q&A pairs that were found to be correct by the auto-reviewer 216). In addition, the fine-tuning system 210 provides automated quality review by utilizing an LLM to automate the generated data review process.

In certain embodiments, the fine-tuning system 210 provides streamlined fine-tuning for multimodal LLMs with a framework that simplifies and speeds up the fine-tuning of multimodal LLMs, increases the ease to use the multimodal LLMs, requiring minimal manual input while producing high-quality results.

In certain embodiments, the fine-tuning system 210 provides increased development speed by accelerating the fine-tuning process, enabling quicker model deployment and reducing time-to-market.

In certain embodiments, the fine-tuning system 210 minimizes manual effort by reducing reliance on manual data annotation and preparation, lowering the risk of errors and enhancing overall data and model quality.

In certain embodiments, the fine-tuning system 210 provides cost efficiency by cutting down labor costs and boosts data processing efficiency, making high-quality model training more affordable, especially for budget-conscious projects.

In certain embodiments, the fine-tuning system 210 introduces a framework that automates the generation of large volumes of high-quality synthetic data, specifically tailored for different tasks. The fine-tuning system 210 integrates automated image captioning and object detection into the data generation process, incorporating detailed image information to produce more accurate and task-specific data. This allows for rapid fine-tuning of multimodal models, while reducing the need for manual data creation and ensuring quick adaptability to new scenarios.

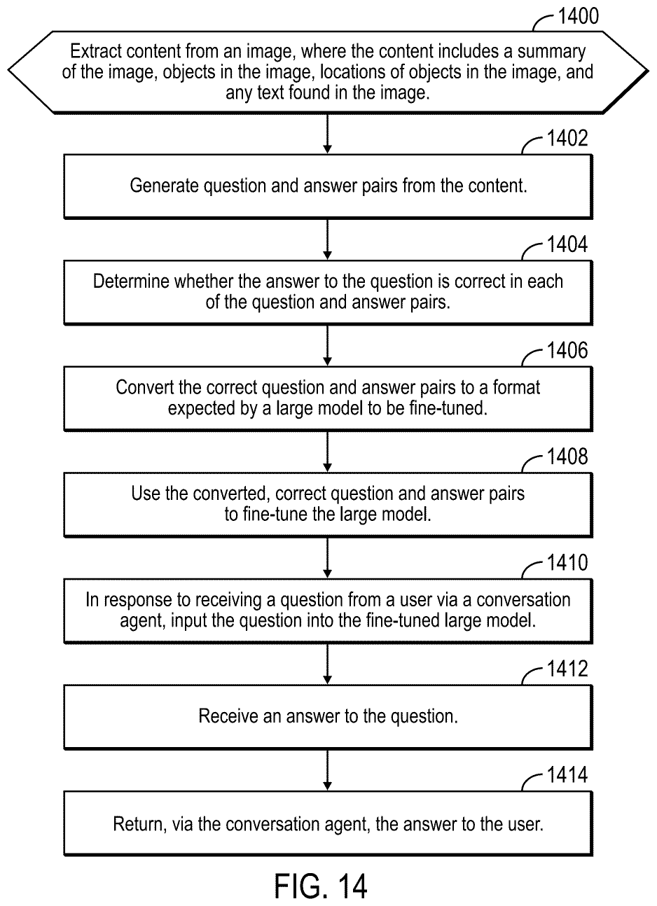

FIG. 14 illustrates, in a flowchart, operations for fine-tuning a large model and using the large model to execute a task in accordance with certain embodiments. Control begins at block 1400 with the fine-tuning system 210 extracting content from an image, where the content includes a summary of the image, objects in the image, locations of objects in the image, and any text found in the image. In block 1402, the fine-tuning system 210 generates question and answer pairs from the content. In block 1404, the fine-tuning system 210 determines whether the answer to the question is correct in each of the question and answer pairs. In block 1406, the fine-tuning system 210 converts the correct question and answer pairs to a format expected by a large model to be fine-tuned.

In block 1408, the fine-tuning system 210 uses the converted, correct question and answer pairs to fine-tune the large model. In block 1410, in response to receiving a question from a user via a conversation agent, the fine-tuning system 210 inputs the question into the fine-tuned large model. In block 1412, the fine-tuning system 210 receives an answer to the question. In block 1414, the fine-tuning system 210 returns, via the conversation agent, the answer to the user.

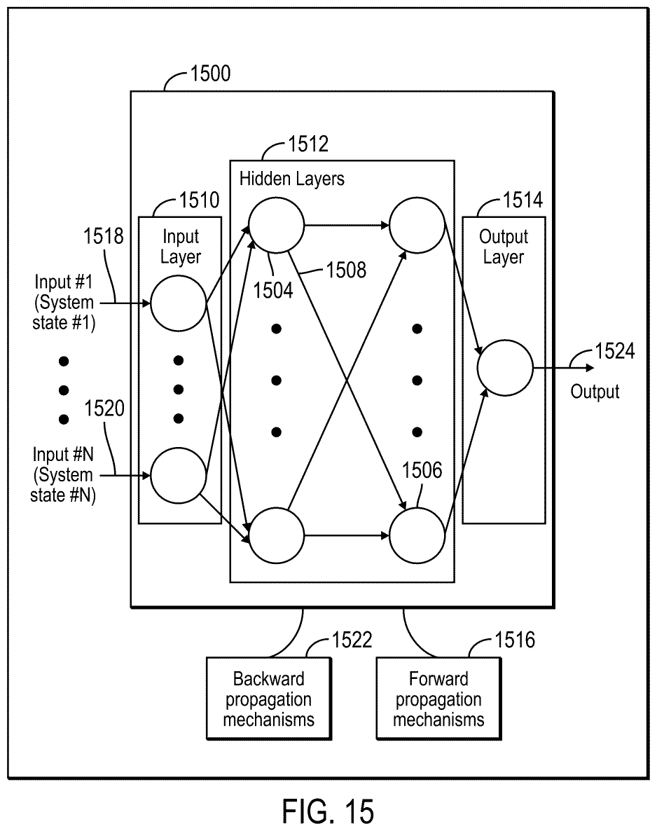

FIG. 15 illustrates, in a block diagram, details of a machine learning model 1500 in accordance with certain embodiments. In certain embodiments, the machine learning models 230 are implemented using the components of the machine learning model 1500.

The machine learning model 1500 may comprise a neural network with a collection of nodes with links connecting them, where the links are referred to as connections. For example, FIG. 15 shows a node 1504 connected by a connection 1508 to the node 1506. The collection of nodes may be organized into three main parts: an input layer 1510, one or more hidden layers 1512, and an output layer 1514.

The connection between one node and another is represented by a number called a weight, where the weight may be either positive (if one node excites another) or negative (if one node suppresses or inhibits another). Training the machine learning model 1500 entails calibrating the weights in the machine learning model 1500 via mechanisms referred to as forward propagation 1516 and backward propagation 1522. Bias nodes that are not connected to any previous layer may also be maintained in the machine learning model 1500. A bias may be described as an extra input of 1 with a weight attached to it for a node.

In forward propagation 1516, a set of weights are applied to the input data 1518. . . 1520 to calculate the output 1524. For the first forward propagation, the set of weights may be selected randomly or set by, for example, a system administrator. That is, in the forward propagation 1516, embodiments apply a set of weights to the input data 1518 . . . 1520 and calculate an output 1524.

In backward propagation 1522 a measurement is made for a margin of error of the output 1524, and the weights are adjusted to decrease the error. Backward propagation 1522 compares the output that the machine learning model 1500 produces with the output that the machine learning model 1500 was meant to produce, and uses the difference between them to modify the weights of the connections between the nodes of the machine learning model 1500, starting from the output layer 1514 through the hidden layers 1512 to the input layer 1510, i.e., going backward in the machine learning model 1500. In time, backward propagation 1522 causes the machine learning model 1500 to learn, reducing the difference between actual and intended output to the point where the two come very close or coincide.

The machine learning model 1500 may be trained using backward propagation to adjust weights at nodes in a hidden layer to produce adjusted output values based on the provided input data 1518 . . . 1520. A margin of error may be determined with respect to the actual output 1524 from the machine learning model 1500 and an expected output to train the machine learning model 1500 to produce the desired output value based on a calculated expected output. In backward propagation, the margin of error of the output may be measured and the weights at nodes in the hidden layers 1512 may be adjusted accordingly to decrease the error.

Backward propagation may comprise a technique for supervised learning of artificial neural networks using gradient descent. Given an artificial neural network and an error function, the technique may calculate the gradient of the error function with respect to the artificial neural network's weights.

Thus, the machine learning model 1500 is configured to repeat both forward and backward propagation until the weights of the machine learning model 1500 are calibrated to accurately predict an output.

The machine learning model 1500 implements a machine learning technique such as decision tree learning, association rule learning, artificial neural network, inductive programming logic, support vector machines, Bayesian models, etc., to determine the output 1524.

In certain machine learning model 1500 implementations, weights in a hidden layer of nodes may be assigned to these inputs to indicate their predictive quality in relation to other of the inputs based on training to reach the output 1524.

With embodiments, the machine learning model 1500 is a neural network, which may be described as a collection of “neurons” with “synapses” connecting them.

With embodiments, there may be multiple hidden layers 1512, with the term “deep” learning implying multiple hidden layers. Hidden layers 1512 may be useful when the neural network has to make sense of something complicated, contextual, or non-obvious, such as image recognition. The term “deep” learning comes from having many hidden layers. These layers are known as “hidden”, since they are not visible as a network output.

In certain embodiments, training a neural network may be described as calibrating all of the “weights” by repeating the forward propagation 1516 and the backward propagation 1522.

In backward propagation 1522, embodiments measure the margin of error of the output and adjust the weights accordingly to decrease the error.

Neural networks repeat both forward and backward propagation until the weights are calibrated to accurately predict the output 1524.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method, comprising operations for:
extracting content from an image, wherein the content comprises a summary of the image, objects in the image, locations of objects in the image, and any text found in the image;
generating question and answer pairs from the content;
identifying a subset of the question and answer pairs for which an answer to a question is correct;
using the subset of the question and answer pairs to fine-tune a large model;
receiving a question from a user;
inputting the question into the fine-tuned large model;
receiving an answer to the question from the fine-tuned large model; and
returning the answer to the user.

2. The computer-implemented method of claim 1, wherein the summary is determined using a vision language model, and wherein the objects and the locations of the objects are determined using a large vision model.

3. The computer-implemented method of claim 1, wherein the question and answer pairs are generated using a question and answer large language model.

4. The computer-implemented method of claim 1, wherein the subset of the question and answer pairs is identified using a verification large multimodal model.

5. The computer-implemented method of claim 1, wherein the operations further comprise:
generating a conversion script using a conversion script large language model; and
converting the subset of question and answer pairs to a format expected by the large model using the conversion script.

6. The computer-implemented method of claim 1, wherein the operations further comprise:
receiving parameters, wherein the large model is fine-tuned based on the parameters and the subset of the question and answer pairs.

7. The computer-implemented method of claim 1, wherein the large model comprises a multimodal large language model.

8. A computer program product comprising:
one or more computer-readable storage media; and
program instructions stored on the one or more computer-readable storage media to perform operations comprising:
extracting content from an image, wherein the content comprises a summary of the image, objects in the image, locations of objects in the image, and any text found in the image;
generating question and answer pairs from the content;
identifying a subset of the question and answer pairs for which an answer to a question is correct;
using the subset of the question and answer pairs to fine-tune a large model;
receiving a question from a user;
inputting the question into the fine-tuned large model;
receiving an answer to the question from the fine-tuned large model; and
returning the answer to the user.

9. The computer program product of claim 8, wherein the summary is determined using a vision language model, and wherein the objects and the locations of the objects are determined using a large vision model.

10. The computer program product of claim 8, wherein the question and answer pairs are generated using a question and answer large language model.

11. The computer program product of claim 8, wherein the subset of the question and answer pairs is identified using a verification large multimodal model.

12. The computer program product of claim 8, wherein the operations further comprise:
generating a conversion script using a conversion script large language model; and
converting the subset of question and answer pairs to a format expected by the large model using the conversion script.

13. The computer program product of claim 8, wherein the operations further comprise:
receiving parameters, wherein the large model is fine-tuned based on the parameters and the subset of the question and answer pairs.

14. The computer program product of claim 8, wherein the large model comprises a multimodal large language model.

15. A computer system comprising:
a processor set;
one or more computer-readable storage media; and
program instructions stored on the one or more computer-readable storage media to cause the processor set to perform operations comprising:
extracting content from an image, wherein the content comprises a summary of the image, objects in the image, locations of objects in the image, and any text found in the image;
generating question and answer pairs from the content;
identifying a subset of the question and answer pairs for which an answer to a question is correct;
using the subset of the question and answer pairs to fine-tune a large model;
receiving a question from a user;
inputting the question into the fine-tuned large model;
receiving an answer to the question from the fine-tuned large model; and
returning the answer to the user.

16. The computer system of claim 15, wherein the summary is determined using a vision language model, and wherein the objects and the locations of the objects are determined using a large vision model.

17. The computer system of claim 15, wherein the question and answer pairs are generated using a question and answer large language model.

18. The computer system of claim 15, wherein the subset of the question and answer pairs is identified using a verification large multimodal model.

19. The computer system of claim 15, wherein the operations further comprise:
generating a conversion script using a conversion script large language model; and
converting the subset of question and answer pairs to a format expected by the large model using the conversion script.

20. The computer system of claim 15, wherein the operations further comprise:
receiving parameters, wherein the large model is fine-tuned based on the parameters and the subset of the question and answer pairs.
